(19) United States
(12) Patent Application Publication
(10) Pub. No.: US 2016/0078316 A1
(43) Pub. Date: Mar. 17, 2016

(54) Simulated Human Cognition Sensor System

(71) Applicant: Michael J. Sherman, Newton, MA (US)

(72) Inventor: Michael J. Sherman, Newton, MA (US)

(73) Assignee: AES CORPORATION, Peabody, MA (US)

(21) Appl. No.: 14/828,314

(22) Filed: Aug. 17, 2015

Related U.S. Application Data
(60) Provisional application No. 62/038,815, filed on Aug. 18, 2014.

(51) Int. Cl. G06K 9/62; G06T 11/60; H04N 5/232; G06F 17/30; G06K 9/00; H04N 5/44

(52) U.S. Cl. CPC G06K 9/6215; G06K 9/00771; H04N 5/44; H04N 5/23245; G06K 9/00718; G06F 17/3028; G06T 11/60; G06K 2009/00738

(57) ABSTRACT

This disclosure relates to systems and methods simulating human cognitive recognition of a threat. The disclosed systems utilize images captured from one or more security cameras to detect potential threats (i.e., reportable events). The images can be compared to template images stored in the system, the template images showing threats to a facility or individuals in the facility. The template images allow the system to determine whether a threat has been detected and whether it should be reported. The disclosed systems can be modified by the user and learn based on updates to the templates.

### FIELD

This disclosure relates generally to the field of motion sensing.

### BACKGROUND

Motion and presence sensors are frequently used in security systems, building energy and management systems and human traffic access control systems. They are characterized as being of very low cost to manufacture and sell. Small in size and purchased in very large volumes of millions per year.

There are several methods of motion and presence detection. Passive Infrared motion detectors are the lowest cost and most widely used motion detectors in use today. These sensors look for the movement of a temperature differential within the field of view. However, these detectors detect only when there is movement in it field of vision. As the moving target approaches the temperature of the background, detection become more difficult. When the target and back ground become the same temperature movement detection is not possible. Similarly if the target does not move detection is not possible. This type of detector often false indicate movement when either hot or cold air blasts or physical items of different temperatures or sun induced heating or cloud induced cooling come into the vision field

Radio sensors detect movement by detecting the Doppler shift reflected from the moving mass in motion. Unfortunately, the detector will respond to the returning Doppler signal as a result of any movement within the radio carrier illuminated area. This can lead to many false positive alarms. In addition, radio signals are difficult to direct and control outside the area of interest. This absolute lack of control makes radio detection a difficult means to detect motion within a confided space. Furthermore, radio sensors are only sensitive to motion of a mass moving through the area of interest, leading to potential false positive and false negative results.

Ultrasonic sensors as radio flood the area with ultrasonic sound. As a mass moves within the area of interest some ultrasonic energy is reflected back to the sensor the sensor measures the Doppler shift and makes a decision as to detection of movement. Ultrasonic sensors suffer from many of the same issues as radio sensors. However, ultrasonic energy will not move through solid surfaces, which leads to a reduction of false positives as compared to radio sensors. Nevertheless, ultrasonic sensors are unable to determine whether a movement is non-threatening or in fact equals a threat that must be reported.

Dual TECH sensor is a detector that employs two methods of detection, such as infrared and Microwave. The theory is that infrared will detect movement by the motion of a temperature difference in the field of view. The microwave will detect when the moving body causes a Doppler shift to the reflected signals. The detector will only signal the presence of a human when both detectors agree that detection has been made. In essence, each detector makes its own decision as to whether it senses human motion. This sensor technology is not widely used because it is expensive and does not improve on the false positive reporting rate of infrared and Microwave technology alone.

Therefore, there remains a need for a sensor system that determines whether an object is a true threat and does not merely report an event based on movement alone. In addition, there remains a need for a sensor system that can learn to distinguish between threatening and non-threatening events.

### SUMMARY

Disclosed herein are systems and methods relating to the simulation of human cognitive recognition. The systems and methods allow for the detection of events, but particularly allow for the discrimination between threats that should be reported to a user or authorized person and non-threats that should not be reported. Unlike prior art systems that depend on movement or temperature, the disclosed systems and methods rely on an organized set of memories to discriminate between threats and non-threats. In particular, the disclosed systems can access past experience (“template images”) and compare to new observations (camera captured images). The systems can further access criteria to determine whether an event captured by the camera(s) of the systems is a threat. The disclosed systems also have the capacity to learn through new images obtained from the camera(s) or uploaded by the user (i.e., authorized person).

Aspects of the systems disclosed herein comprise a cognitive recognition system for detection of threats. The system comprises one or more cameras, wherein the cameras are operably linked (e.g., wireless, broadband, DSL, optical) to a processor. The system further comprises a volatile memory for storing an image obtained by the one or more cameras and one or more non-volatile memories (e.g., two non-volatile memories). The non-volatile memories store criteria for determining whether the image detects a threat, determining whether the threat in the image should be reported, and one or more template images used for comparison to the image stored in the volatile memory. The system further comprises a memory comprising executable instructions, wherein the processor executes the instructions to: (i) access the volatile memory to obtain the image; (ii) access the non-volatile memories to identify one or more template images; (iii) compare the image to one or more template images; (iv) identify a template image that is similar to the image; (v) access criteria stored in the non-volatile memories; and (vi) calculate whether the image identifies a threat (i.e., reportable event) that must be reported to an authorized person.

In some embodiments, the one or more non-volatile memories are two non-volatile memories. In particular embodiments, a first non-volatile memory stores the criteria and a second non-volatile memory stores the template images. One of ordinary skill in the art will recognize that the images stored by the one or more cameras can be stored in a non-volatile memory. Likewise, one of ordinary skill in the art will recognize that the criteria and template images can be stored in volatile memory. The embodiments disclosed herein are meant to teach exemplary uses and operations of the systems disclosed herein.

In certain embodiments, the system comprises a user interface. In some embodiments, the user interface is a network interface. In other embodiments, the camera is a digital camera. In still other embodiments, the camera is an analog camera. In yet other embodiments, the one more cameras are connected to the processor via a wireless connection. In some embodiments, the system further comprises a digital image converter operably connected to the analog camera and to the processor.

In certain embodiments, the system transmits data to authorized individuals via a connection such as wireless, telephone line, broadband, DSL, and optical connections. In some embodiments, the data is transmitted using a standard selected from the group consisting of RS-232 and RS-485. In other embodiments, the system is operably connected to an alarm via a relay (e.g., the alarm is audible or silent). In certain embodiments, the authorized person is selected from the group consisting of user, security personnel, emergency personnel, police, and combinations thereof. In some embodiments, the system transmits an image to a display at a security station over a network.

In particular embodiments, the system further comprises executable instructions for the processor to execute to store one or more images from the volatile memory to the one or more non-volatile memories. In more particular embodiments, the system further comprises executable instructions for the processor to execute to store one or more images from the volatile memory to the one or more non-volatile memories.

In certain embodiments, one of the one or more non-volatile memories are divided into a permanent template memory and a learned template memory. In more embodiments, the system further comprises executable instruction for the processor to execute to categorize one or more template images as indicating a potential reportable event, such as a threat to a facility. In yet more embodiments, the system further comprises executable instruction for the processor to execute to allow a user to access the one or more non-volatile memories to modify, add, or remove one or more criteria.

In additional embodiments, the system further comprises executable instruction for the processor to execute to allow a user to access the one or more non-volatile memories to add, remove, or recategorize one or more template images. In more additional embodiments, the system further comprises executable instruction for the processor to execute to subtract information from the image in volatile memory from one or more template images in non-volatile memory. In further embodiments, the system further comprises executable instruction for the processor to execute to calculate a threat level (i.e., reportable event level) based on the image in volatile memory and compare the threat level (i.e., reportable event level) to the threshold specified for reporting the threat (i.e., reportable event). In yet further embodiments, the system further comprises executable instructions for the processor to execute to alter the frame speed of the one or more cameras based on the identification of a potential threat (i.e., reportable event).

Additional aspects disclosed herein relate to a method for cognitive recognition of possible threats (i.e., reportable events). The method comprises providing one or more cameras operably linked to a processor and storing one or more images from the one or more cameras in a volatile memory. The method further comprises accessing one or more non-volatile memories, wherein the non-volatile memories store criteria for determining whether the threat in the image should be reported, for determining whether the image detects a threat, and one or more template images stored in the non-volatile memory. The method also comprises accessing the one or more images in the volatile memory and comparing the one or more images to one or more template images.

In some embodiments, the method comprises identifying a template image that is similar to the one or more stored images. In other embodiments, the method comprises accessing criteria stored in the non-volatile memories to determine whether the template image similar to the one or more images stored identifies a threat (i.e., reportable event) and calculating whether the image identifies a threat (i.e., reportable event) that must be reported to an authorized person.

In certain embodiments, the one or more cameras are operably linked to the processor by a network connection. In other embodiments, the network connection is selected from the group consisting of broadband, optical, wireless, DSL, and telephonic.

In particular embodiments, one or more non-volatile memories are two non-volatile memories. In more particular embodiments, a first non-volatile memory stores criteria for determining whether a threat has been detected and a second non-volatile memory stores the one or more template images. In even more particular embodiments, the one or more template images are stored in the system by the authorized person.

In more embodiments, the one or more template images are categorized according to whether the images represent a threat or non-threat. In still more embodiments, the method further comprises storing an image from volatile memory into the one or more non-volatile memories after the image has been categorized as a threat or non-threat. In further embodiments, the method further comprises accessing the one or more template images in the non-volatile memories using a memory map. In yet further embodiments, the method further comprises allowing the authorized person (e.g., user) to recategorize the one or more template images stored in the one or more non-volatile memories.

In certain embodiments, comparing the one or more template images to the one or more images comprises image subtraction and/or image alteration (e.g., scaling) to identify the differences between the one or more template images to the one or more images. Image alteration—for example, scaling—can be necessary for certain comparisons between template images and images in volatile memory due to differences in lighting in the images, size of objects in the images, and angle of objects relative to the camera in the images. In other embodiments, comparing the one or more template images to the one or more images comprises overlaying a template image over an image to identify similarities between the template image and the image. In yet other embodiments, comparing the one or more template images to the one or more images comprises approximating the similarities between the template image and the image. In still other embodiments, comparing the one or more template images to the one or more images comprises using a keypoint matching algorithm. In some embodiments, the user can set a particular match score for the system to utilize when comparing template images to images in volatile memory. For instance, the user can set a score in non-volatile memory instructing the system to accept as similar an image that appears to be 50% similar to a template image. The user could also set the match score lower (i.e., making the matching less stringent) or higher (i.e., making the matching more stringent). In particular embodiments, the keypoint matching algorithm identifies similarities between a template image and an image. In more particular embodiments, comparing the one or more template images to the one or more images comprises approximating the similarities between the template image and the image.

In other embodiments, the method further comprises allowing the authorized person to set a limit by which the template image is determined to be similar to the image. In more embodiments, the method further comprises allowing the authorized person to modify the criteria for determining whether a threat has been identified.

In many embodiments, the criteria are selected from the group consisting of time of day, whether an object is an individual, whether the individual is authorized to be in the area, whether an event is occurring that is undesired, whether smoke is detected, whether fire is detected, whether an individual has a weapon, and combinations thereof.

In particular embodiments, the method further comprises reporting the threat to a display at a security station. In more particular embodiments, the display shows only an image when a threat is suspected or the threat is probable.

In certain embodiments, the method further comprises modifying the frame speed of the one or more cameras when a potential threat is detected. In some embodiments, the frame speed is increased from a low shutter rate to a higher shutter rate when a threat is suspected.

In other embodiments, the method further comprises comparing a first image in volatile memory to a second image in volatile memory to determine the differences between the images. In still other embodiments, the comparison is performed using a subtraction algorithm.

In more embodiments, the method further comprises updating the non-volatile memories with one or more images stored in the volatile memory so as the one or more images are categorized as template images. In still more embodiments, the template images are categorized so as to allow the authorized person to identify the template images as being from the volatile memory. In yet more embodiments, the authorized person modifies the template images stored from volatile memory.

In particular embodiments, the method further comprises uploading one or more template images into the non-volatile memories. In still more particular embodiments, the one or more template images are staged to show a threat (i.e., reportable event).

### BRIEF DESCRIPTION OF THE FIGURES

To further understand the systems and methods disclosed herein, reference is directed to the following brief description of the figures as well as the drawings that show exemplary embodiments of the systems and methods:

FIG. 1 is a schematic representation showing an embodiment of a system within the scope of the disclosure.

FIG. 2 is a schematic representation showing an exemplary process by which the system discriminates between threatening and non-threatening objects.

FIG. 3 is a schematic representation showing how a user can modify the threat threshold for an exemplary system.

### DETAILED DESCRIPTION

Disclosed herein are systems and methods that allow for the detection of events that rise to the level of threats in an area monitored by camera surveillance. The disclosed systems have the capacity to differentiate between non-reportable events and reportable threats to a user, the police, emergency personnel, or the security of a facility. Such systems also comprise the capacity to learn from events and user-inputted information to discriminate between likely security threats and false threats. The disclosed systems further allow for intelligent notification of security personnel to likely threats. One of ordinary skill in the art will recognize that the disclosed systems can be contained in a single container. However, the disclosed systems can also be a plurality of separate components connected through network communications.

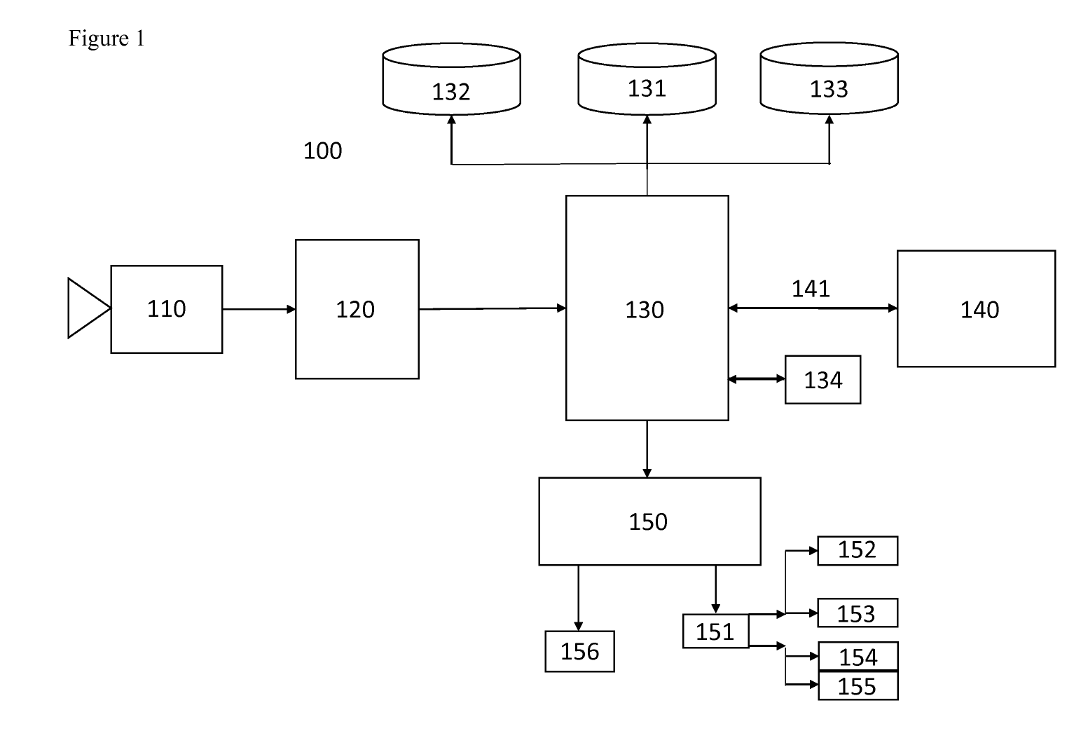

FIG. 1 shows an exemplary system within the scope of the disclosure. The system 100 comprises a camera 110 having a plurality of LEDs or other lighting devices to illuminate an area (e.g., 2 or more LEDs, infrared lights, etc.) operably linked to the system 100. The linkage can be a wireless connection, broadband, DSL, optical, cable connection that allows for data to be transmitted to the system 100. The camera 110 can be a digital or analog camera. In particular embodiments, the camera 110 can be a low-resolution camera (less than 1 mega-pixel). In other embodiments, the camera 110 can be a higher resolution camera of greater than 1 megapixel. In further embodiments, the camera 110 is capable of shutter speeds of 1/250 or faster. In other embodiments, the camera 110 is programmed to have a shutter speed of less than 1/250.

Returning to FIG. 1, the system 100 further comprises a digital converter 120 when the camera 110 is an analog camera. The digital converter 120 converts the images into digital format to store in memory. The images can be stored in any format that allows for comparison and analysis of different digital images (e.g., Raster formats as JPEG, TIFF, RAW, JPG, PPM, GIF, BMP, PNG, PPM, SVG, RIF, WEBP, BPG, as well as HDR Motion formats such as mpeg and MOV). The digital converter 120 is connected to a CPU or processor 130. In the event that the camera 110 is a digital camera, the camera 110 is connected to the processor 130. The processor 130 executes instructions that are located in a memory (not shown). The processor 130 is operably linked to the volatile memory 131, as well as non-volatile memories 132 and 133. The system 100 comprises a clock 134 that maintains the time of day, day of week, and the date. The clock 134 allows the system 100 to keep stored files according to time, day of week, and date. As explained further below, the clock 134 also allows the user 140 to instruct the system 100 as to when certain events are reportable events depending on the time of day, day of week, and date.

Volatile memory 131 stores images captured by one or more cameras 110. The processor 130 comprises instructions to access the volatile memory 131 as a first step to determine whether a particular image captured by the one or more cameras 110 represents a potential threat. The volatile memory 131 can be a random access memory such as DRAM or SRAM. The volatile memory 131 acts as the initial repository of the images captured by the one or more cameras 110; however, the images stored in volatile memory 131 can be stored in non-volatile memory 133, as described more fully herein.

The processor 130 also comprises instructions to store and retrieve information in the non-volatile memories 132 and 133. The processor 130 uses the information stored in the non-volatile memories 132 and 133, in conjunction with the image(s) stored in volatile memory 131, to determine whether a particular event requires reporting as a threat. The non-volatile memories 132 and 133 can be a suitable storage medium that allows for long-term storage of information that can be modified by the user 140. Examples of non-volatile memories include, but are not limited to, mask ROM, EPROM, FRAM, solid-state storage, hard disk storage, optical drive, and flash memory.

The non-volatile memories 132 and 133 store information that the processor 130 uses to determine whether a threat exists and should be reported. The non-volatile memory 132 provides the logic for the system 100. The non-volatile memory 132 allows for the user 140 to instruct (“teach”) the system 100 how to differentiate between a reportable event and a non-reportable event. As used herein, the term “reportable” refers to individuals, events, or occurrences that rise to the level of requiring an alert, alarm, or report to an authorized person. The term “reportable” can be used to refer to “unfriendly” individuals such as intruders, aggressors, or other individuals who are deemed to be unauthorized in a particular area. The term “unfriendly” can also refer to events such as smoke, fires, weather events, or acts of nature that are deemed to be undesirable. Alternatively, non-reportable events can be deemed to be “friendly” such as normal conditions, or individuals who are authorized to be in a particular area, such as friends, families, employees, or other individuals.

Returning to non-volatile memory 132, the user 140 provides the system 100 with criteria that allow the system 100 to differentiate between images that show a reportable event and images that show a non-reportable event. In this way, the system 100 mimics human cognition by referring to its “past experience”—template images stored in the non-volatile memory 133—and using the criteria stored in non-volatile memory 132 to compare the past experiences to the images captured by camera(s) 110 and stored in volatile memory 131. The system 100 therefore intelligently differentiates between events rather than merely reporting every event that is detected. For instance, the user 140 can set almost any parameter relating to events that the user 140 desires. If the user 140 desires that any event occurring at a particular time is reportable, then the user 140 can instruct the system 100 that events occurring at that time should be reported. This can be useful in situations such as industrial facilities that are closed at particular hours. The user 140 can also instruct the system 100 that events occurring on certain days are reportable—such as holidays or days when a facility is closed. The user 140 can also instruct the system 100 to be aware of individuals who appear to be threatening, such as those individuals holding weapons or who are in restricted access areas. The user 140 provides the non-volatile memory 132 with the criteria through a user interface 141. The non-volatile memory 132 stores the information relating to criteria, which will be later used to allow the system 100 to determine whether an event qualifies as a reportable event to be reported to the user 140 or other personnel. Exemplary criteria include the time of day of an event, day of week, date of event, the type of individual observed in an area (e.g., family member, friend, individual with security clearance in a facility, etc.), whether an individual has a weapon, whether an individual is threatening an individual or property, whether an unauthorized vehicle or other object of importance is in an area, and any other criteria specified by the user 140 to be of importance.

As disclosed above, the non-volatile memory 133 stores information relating to images (so called, “templates”) that represent non-reportable(non-threat) scenarios and reportable (threat) scenarios. The templates stored in non-volatile memory 133 represent the template memory of the system 100 and are a type of “past experience” of the system 100. The template memory allows the system 100 to categorize events as either threatening or non-threatening. The images stored in non-volatile memory 133 can include non-reportable images such as family members, individuals authorized to be in a particular location (e.g., friends of the family, employees credentialed to be in a facility, security personnel), and images of property or buildings when no one is on the property or in the building. The images can also be of reportable images including an individual holding a weapon (e.g., knife, gun, or other device), an individual in a threatening pose, an unauthorized individual in a particular region in a facility or on a property, unauthorized vehicles, smoke, and fire. The past experiences allow the system 100 to compare these experiences to the images stored in volatile memory 131. This comparison is followed by the system 100 referring to the human-type logic stored in non-volatile memory 132 to differentiate between reportable and non-reportable events.

Template images can be staged to teach the system 100 what a likely reportable event looks like. For instance, the user 140 can take pictures of an individual posing with a knife or rifle. The normal condition of the area can also be stored as a template, allowing the system 100 to identify the normal lighting, environment, and normal objects located in the area. The user 140 can also stage what a reportable event would look like and upload the image to the system 100. The images are uploaded into the system 100 by way of a user interface 141 and the user 140 is able to categorize the image as either reportable or non-reportable. The processor 130 stores the uploaded images into non-volatile memory 133 for future access in the appropriate files as designated by the user 140. The user 140 can also instruct the processor 130 to remove images from the non-volatile memory 133 or alternatively to recategorize images as either reportable or non-reportable through the user interface 141.

One of ordinary skill in the art understands that the system 100 is making probabilistic determinations of whether a reportable event has occurred based on the criteria stored in the non-volatile memory 132. The system 100 compares a template image (“past experience”) to an image stored in volatile memory 131, which has been captured by camera 110. The system 100 looks to the criteria stored in non-volatile memory 132 and “reasons” through whether a reportable event has occurred. The system 100, based on scanning the criteria, can determine whether a particular event is more likely than not to be reportable. The user 140 can set the threshold for determining whether an event is reportable in several ways. In one way, the analysis can be a single step analysis. For instance, the user 140 can instruct the system that any event occurring in an area at a time when all events is reportable. If the event occurs, the system 100 determines that the event is more likely than not to be reportable. Alternatively, the user 140 can instruct the system to step through a series of criteria before determining whether the event is reportable. In this example, the system 100 must answer in the affirmative two or more criteria prior to determining whether an event is more likely than not reportable.

To perform the function of determining whether the one or more cameras 110 captured an image of a reportable event, the processor 130 comprises instructions that allow for access and retrieval of templates from the non-volatile memory 133 upon the storing of the image in volatile memory 131. The processor 130 comprises instructions to match the most similar template in non-volatile memory 133 to the image stored in volatile memory 131. The processor 130 executes instructions to identify similarities between the image from volatile memory 131 and images from non-volatile memory 133.

Digital image comparison techniques to identify similar images are well known in the art (see, e.g., U.S. Pat. Nos. 5,907,641; 8,229,230; and United States Publication No. 2006/0159347, the disclosures of which are incorporated in their entireties). A common method of digital image comparison involves three main steps: a first step in which reference points are selected in a first image; a second step in which reference points corresponding to those selected in the first image are selected in a second image; and a third step in which the parameters of the transformation function relating corresponding reference points in the two images are calculated, e.g. by means of a least mean square algorithm. Another method involves generating a representation of a digital image according to the present invention involves converting the original image into a square bitmap and then dividing that bitmap into a plurality of square cells (see U.S. Pat. No. 6,690,828, the disclosure of which is incorporated in its entirety). This technique allows for rapid image similarity determinations using limited data.

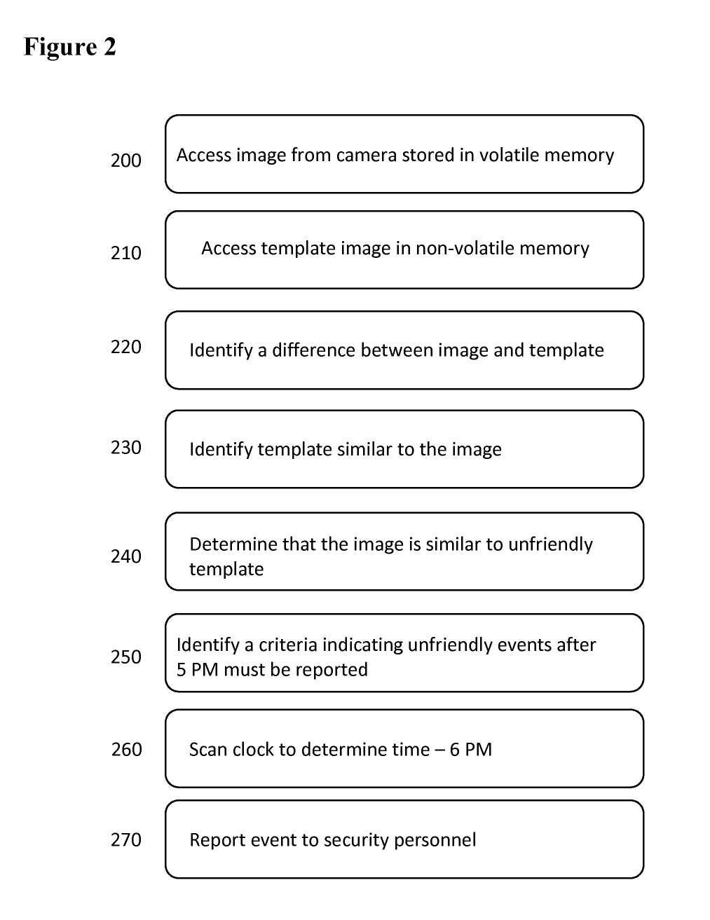

The comparison in this embodiment can be performed in multiple steps, as shown in FIG. 2. The embodiment in FIG. 2 starts with the processor accessing an image from volatile memory captured by a camera monitoring an area, in this example, a corridor in a building 200. The processor accesses a template image of the corridor stored in the non-volatile memory 210. The processor executes instructions to identify a difference between the image and the template 220. In this embodiment, the processor identifies a difference between the images 230. In other embodiments described herein, the processor does not identify differences between a template and an image, but rather determines similarities between a template and an image without performing the step of finding a template of a difference. In this example, the processor identifies a difference because the processor first attempts to determine whether an individual is in the corridor. The processor scans the templates stored in non-volatile memory and identifies a template that is similar to the image 240. The template shows that the object in the corridor is an individual and no such individual should be in the corridor. The image is categorized as reportable 240.

Upon identifying the reportable image, the processor accesses non-volatile memory to identify the criteria for reporting a threat 250. The user has set the criteria for reporting a threat as “Report” when the time of day is after 5 PM 250. The processor checks the computer's clock 260 and determines the time is 6 PM. The processor executes instructions to report the threat to a security station video screen 270. Upon the report of the threat, the display on the video is activated on the security personnel are alerted to the individual, as well as the location of the camera where the event occurred. In this way, the system prevents the security personnel from monitoring continually all cameras. Instead, the security personnel are only alerted to attention when a threat is determined to exist by the system.

As shown in FIG. 1, the system 100 can comprise different methods of reporting a threat (so called “output”) 150. In some embodiments, the report is sent as data 151 such as to the user 140 through an IP/TCP connection or other data connection (e.g., fiber) 152 or to a display used by security personnel 153. In particular embodiments, the report is data sent using RS-232 standard through a serial port 154. In more embodiments, the report is data sent through a local network or multi-drop communications link using RS-485 155. In other embodiments, the processor outputs a signal to a relay 156 that sets off an alarm (audible or silent).

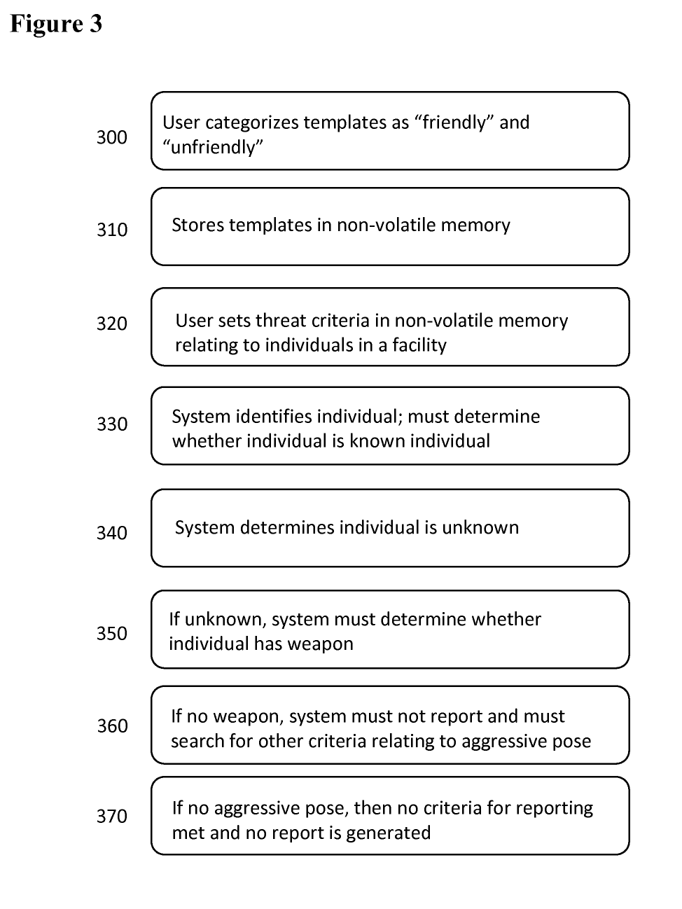

In certain embodiments, the user programs the system to determine what events rise to reportable threats (FIG. 3). The processor can utilize the templates and criteria set by the user to prioritize an event as a reportable threat or a non-reportable event. For example, the user (authorized person) categorizes certain templates of individuals as “friendly” such as employees of the company and staged templates of individuals with weapons or in aggressive poses as reportable 300 (FIG. 3). The user can also teach the system that any unidentified individual/event is reportable. The templates are stored in non-volatile memory 310.

In FIG. 3, the user also sets criteria in non-volatile memory for the determination of threat levels 320. The user instructs the system to determine whether the individual is known 330. If the individual is unknown, the user does not code this as a reportable event in this example 340. The processor is instructed to scan through the other criteria if the individual is unknown. The user provides a criteria which demands that the system determine whether the individual has a weapon 350. If the processor determines, based on the comparison of an image from volatile memory to a template from non-volatile memory, that the individual has a weapon, this criteria meets the reportable threat threshold and is reported. In this embodiment, the individual does not appear to have a weapon; therefore, the processor does not yet report and searches the other criteria set in the system 360. The user has set criteria for whether the individual has an aggressive posture, such as a first raised in a threatening position or the individual is lunging forward toward another individual. The processor compares the image to templates and determines that the image does not match any reportable templates showing aggression. The processor determines that the event is not a reportable event, even though the individual is technically reportable due to being unidentifiable 370. As shown in this embodiment, the user can set the threshold criteria for reporting an event at a very high threshold so that few events are reported (e.g., times of day when individuals are expected) or at a low threshold so that most events are reported (e.g., high security facilities, smoke, fire, or times of day when no one should be in an area).

Aspects of the disclosed systems include the ability of the system 100 to learn through past experience. In certain embodiments, the system 100 modifies the template memory in non-volatile memory 133 (FIG. 1). When images are captured by the one or more cameras 110, the processor 130 executes instructions to determine whether the images appear to be reportable or non-reportable. Once this determination is made, the processor 130 can store the image into “learned” template memory located in non-volatile memory 133. For instance, when the system 100 determines that a particular image is most similar to an reportable image located in non-volatile memory 133, the processor 130 stores the image as a new template in the reportable file(s) of the non-volatile memory 133. This process allows the system 100 to refine and update its past experiences, allowing for improved reportable threat detection.

The system 100 can also be trained to interpret motion as either reportable or non-reportable. In certain embodiments, the non-volatile memory 133 contains images of common movement in an area, such as in an industrial facility. These templates allow the system 100 to properly determine that expected movements in an area, such as a rotating fan blade, are not reportable threats. On the other hand, the system 100 can compare an image taken by one or more of the cameras 110 showing unexpected movements as compared to the templates, allowing the processor 130 to scan stored criteria to determine whether the unexpected movement is a reportable threat.

In further embodiments, the user 140 accesses the processor 130 to instruct the system 100 to alter the frame rate of the camera(s) 110. In some embodiments, the user 140 selects a low frame rate when the system 100 is not in an alert state. This passive state exists when the system 100 has not detected a potential reportable event. The user 140 can instruct the system 100 to increase the frame rate of one or more cameras in the system 100 when a camera identifies a potential reportable event. This state, the alert state, can allow for more images to be analyzed by the system, thereby increasing the accuracy of determining whether an event is reportable.

Returning to FIG. 1, the user 140 can access the processor 130 through a network interface 141. The processor 130 can be located at computing device such as a computer or a server. Furthermore, the system 100 can comprise security to ensure that only authorized users can access and/or modify the system 100. The Advanced Encryption Standard can be used to ensure security (see, e.g., Daemon et al. (Mar. 9, 2003). AES Proposal: Rijndael. National Institute of Standards and Technology, p. 1). Other encryption techniques are known to those of ordinary skill in the art, such as Sophos SafeGuard Enterprise Encryption 7 and Vormetric Transparent Encryption.

In some embodiments, the user 140 will desire to update or modify the templates in the non-volatile memory 133. The user 140 can access the system 100 through a web-based application over a wireless network or through Ethernet. The user 140 can access the system 100 through a hardwire connection to the system 100. The user 140 can review saved templates in the non-volatile memory 133. The user 140 can determine whether certain templates should be removed to enhance the accuracy of non-volatile memory 133. The user 140 thus can remove templates that the system 100 erroneously interpreted as reportable threats—reportable—(“false positives”) and erroneously interpreted as non-reportable threats—non-reportable—(“false negatives”). The user 140 can also update the system 100 by recategorizing certain templates from reportable to non-reportable depending on changed circumstances. In certain embodiments, a memory map allows for the system 100 to determine where templates exist in the non-volatile memory 133. For instance, a user 140 could recategorize the image of an employee who recently left a company from non-reportable to reportable. Accordingly, the user 140 has access rights to modify the non-volatile memory 133 to improve accuracy of system threat identification.

The user 140 can also access the system 100 through the processor 130 to modify the non-volatile memory 132. In certain embodiments, the user 140 can alter the criteria stored in the non-volatile memory 132 to either remove, alter, or add criteria.

In particular embodiments, the system approximates the closeness of an image captured by the camera(s) of the system and the templates stored in non-volatile memory. One method to perform similarity analyses between images and templates is keypoint matching such as SIFT keypoints (see, e.g., Lowe. Int. J. Comp. Vis., 60(2):91-110 (2004)). Keypoint matching requires that correlating features can be identified between two images. As such, if correlating features cannot be identified in two images, then images cannot be categorized together.

Regarding similarity analyses, the user can set thresholds for how closely an image from volatile memory must match a template from non-volatile memory prior to a report being sent. For example, the user can specify that an image must match the template of an individual holding a gun by 50% for all portions of the image relating to the individual. If the system determines that the image of the individual is greater than 50% similar to a template of an individual holding a gun, then the system reports the event due to it being more likely than not to be a reportable event. The user can increase the stringency of the reportable event determination (i.e., require a closer match between the template and the image) or decrease the stringency (i.e., require a less close match).

In particular embodiments, the system comprises image alteration algorithms that allow for the system to perform the function of comparing the template images to images captured by the camera(s). The template image will often be an idealized image of an event that would be reportable or non-reportable—such as a staged image of an intruder. The image captured by the camera(s) could differ regarding lighting, angle of the individual relative to the camera, size of the individual, and other factors. To account for these differences, the system can alter the image in volatile memory through scaling. Scaling techniques include bilinear and bicubic interpolation. These techniques work by interpolating pixel color values, introducing a continuous transition into the output even where the original material has discrete transitions. In certain techniques, the algorithm reduces contrast (sharp edges) in a way that may be undesirable for line art. In addition, nearest-neighbor interpolation can be used to ensure the preservation of sharp edges. Techniques well known in the art include 2x Sa1, Super 2x Sa1, hq2x, hq3x, hq4x, xBR, xBRz, RotSprite, Kopf-Lischinski, xBR 3x, and Super-xBR 4x.

Image alteration also includes the resizing of particular aspects of the image. For instance, an individual in the image can have arms lengthened or shortened. The neck, head, or other feature can be widened, shortened, lengthened, or otherwise altered to improve the comparison between the template image and the image captured by the camera. Image manipulation algorithms include Adaptive Filters, Arithmetic Mean Filter, Circularity, Class Grouping Index, Color Tint Correction, Contrast Correction, and Gaussian Filters.

In particular embodiments, the comparison analysis of the system is performed on only those features of the image that appear to be an object such as an individual. The system can compare the image showing a potential intruder to a template showing such an intruder. The system accordingly performs the similarity analysis on the portion of the image showing the potential event. For instance, an intruder enters a facility. The camera(s) of the facility observe the intruder and images are stored in the volatile memory. The processor accesses the template memory and compares the image to a template showing the facility without the intruder. The system subtracts the image from the template and determines that the image contains a potential intruder. The presence of the intruder alone is not a reportable threat in this example. However, the system compares the image to other templates to determine if the intruder is a reportable threat based on criteria such as if the intruder is holding a weapon.

### Equivalents

Those skilled in the art will recognize, or be able to ascertain, using no more than routine experimentation, numerous equivalents to the specific embodiments described specifically in this disclosure. Such equivalents are intended to be encompassed in the scope of the following claims. In particular, one of ordinary skill in the art will recognize that the disclosed systems and methods can be modified such that the images captured by the camera(s) can be stored in non-volatile memories, while the criteria and template images can be temporarily stored in volatile memories. The disclosure set forth herein should not be construed to be narrowly focused on criteria and template images being only stored in non-volatile memory. Nor should the disclosure be narrowly construed such that images captured by the one or more cameras can only be stored in volatile memory.

What is claimed:

1. A cognitive recognition system for detection of threats comprising:
(a) one or more cameras, wherein the cameras are operably linked to a processor;
(b) a volatile memory for storing an image obtained by the one or more cameras;
(c) one or more non-volatile memories, wherein the non-volatile memories store criteria for determining whether the image detects a threat, and determining whether the threat in the image should be reported, and one or more template images used for comparison to the image stored in the volatile memory;
(d) a memory comprising executable instructions, wherein the processor executes the instructions to:
(i) access the volatile memory to obtain the image;
(ii) access the non-volatile memories to identify one or more template images;
(iii) compare the image to one or more template images;
(iv) identify a template image that is similar to the image;
(v) access criteria stored in the non-volatile memories; and
(vi) calculate whether the image identifies a threat that must be reported to an authorized person.

2. The system of claim 1, wherein the authorized person is selected from the group consisting of user, security personnel, emergency personnel, police, and combinations thereof.

3. The system of claim 1, wherein the system is operably connected to an alarm via a relay.

4. The system of claim 3, wherein the alarm is audible or silent.

5. The system of claim 1, wherein the one or more non-volatile memories are two non-volatile memories.

6. The system of claim 5, wherein a first non-volatile memory stores the criteria and a second non-volatile memory stores the template images.

7. The system of claim 1, wherein the system comprises a user interface.

8. The system of claim 7, wherein the user interface is a network interface.

9. The system of claim 1, wherein the camera is a digital camera.

10. The system of claim 1, wherein the camera is an analog camera.

11. The system of claim 10 further comprising a digital image converter operably connected to the analog camera and to the processor.

12. The system of claim 1, wherein the one more cameras are connected to the processor via a wireless connection.

13. The system of claim 1, wherein system transmits data to authorized individuals via a connection.

14. The system of claim 13, wherein the data is transmitted via the connection selected from the group consisting of wireless, telephone line, broadband, DSL, and optical.

15. The system of claim 13, wherein the data is transmitted using a standard selected from the group consisting of RS-232 and RS-485.

16. The system of claim 1, wherein the system transmits an image to a display at a security station over a network only when the system detects a potentially reportable event.

17. The system of claim 1 further comprising executable instructions for the processor to execute to store one or more images from the volatile memory to the one or more non-volatile memories.

18. The system of claim 1 further comprising executable instructions for the processor to execute to store criteria in the non-volatile memory inputted from the user.

19. The system of claim 1, wherein one of the one or more non-volatile memories are divided into a permanent template memory and a learned template memory.

20. The system of claim 1 further comprising executable instruction for the processor to execute to categorize one or more template images as indicating a threat.

21. The system of claim 1 further comprising executable instruction for the processor to execute to allow a user to access the one or more non-volatile memories to modify, add, or remove one or more criteria.

22. The system of claim 1 further comprising executable instruction for the processor to execute to subtract information from the image in volatile memory from one or more template images in non-volatile memory.

23. The system of claim 1 further comprising executable instruction for the processor to execute to calculate a threat level based on the image in volatile memory and compare the threat level to the threshold specified for reporting the threat.

24. The system of claim 1 further comprising executable instructions for the processor to execute to alter the frame speed of the one or more cameras based on the identification of a potential threat.

25. A method for cognitive recognition of possible threats, the method comprising:
(a) providing one or more cameras operably linked to a processor;
(b) storing one or more images from the one or more cameras in a volatile memory;
(c) accessing one or more non-volatile memories, wherein the non-volatile memories store criteria for determining whether the threat in the image should be reported, for determining whether the image detects a threat, and one or more template images stored in the non-volatile memory;
(d) accessing the one or more images in the volatile memory;
(e) comparing the one or more images to one or more template images;
(f) identifying a template image that is similar to the one or more images;
(g) accessing criteria stored in the non-volatile memories to determine whether the template image similar to the one or more images identifies a threat; and
(h) calculating a percent correlation of one or more templates to confirm that the image identifies a reportable event that must be reported to an authorized person.

26. The method of claim 25, wherein the one or more cameras are operably linked to the processor by a network connection.

27. The method of claim 26, wherein the network connection is selected from the group consisting of broadband, optical, wireless, DSL, and telephonic.

28. The method of claim 25, wherein one or more non-volatile memories are two non-volatile memories.

29. The method of claim 28, wherein a first non-volatile memory stores criteria for determining whether a reportable event has been detected and a second non-volatile memory stores the one or more template images.

30. The method of claim 25, wherein the one or more template images are stored in the system by the authorized person.

31. The method of claim 25, wherein the one or more template images are categorized according to whether the images represent a threat or non-threat.

32. The method of claim 25 further comprising storing an image from volatile memory into the one or more non-volatile memories after the image has been categorized as a reportable event or a non-reportable event.

33. The method of claim 25 further comprising accessing the one or more template images in the non-volatile memories using a memory map.

34. The method of claim 25 further comprising allowing the authorized person to recategorize the one or more template images stored in the one or more non-volatile memories.

35. The method of claim 25, wherein comparing the one or more template images to the one or more images comprises image subtraction to identify the differences between the one or more template images to the one or more images.

36. The method of claim 25, wherein comparing the one or more template images to the one or more images comprises overlaying a template image over an image to identify similarities between the template image and the image.

37. The method of claim 36, wherein comparing the one or more template images to the one or more images comprises approximating the similarities between the template image and the image.

38. The method of claim 25, wherein comparing the one or more template images to the one or more images comprises using a keypoint matching algorithm.

39. The method of claim 38, wherein the keypoint matching algorithm identifies similarities between a template image and an image.

40. The method of claim 39, wherein comparing the one or more template images to the one or more images comprises approximating the similarities between the template image and the image.

41. The method of claim 40 further comprising allowing the authorized person to set a limit by which the template image is determined to be similar to the image.

42. The method of claim 25 further comprising allowing the authorized person to modify the criteria for determining whether a threat has been identified.

43. The method of claim 25, wherein the criteria are selected from the group consisting of time of day, day of week, date, whether an object is an individual, whether the individual is authorized to be in the area, whether an event is occurring that is undesired, whether smoke is detected, whether fire is detected, whether an individual has a weapon, and combinations thereof.

44. The method of claim 25 further comprising reporting the threat to a display at a security station.

45. The method of claim 44, wherein the display shows only an image when a reportable event is probable.

46. The method of claim 25 further comprising modifying the frame speed of the one or more cameras when a potential reportable event is detected.

47. The method of claim 46, wherein the frame speed is increased from a low shutter rate to a higher shutter rate when a reportable event is probable.

48. The method of claim 25 further comprising comparing a first image in volatile memory to a second image in volatile memory to determine the differences between the images.

49. The method of claim 48, wherein the comparison is performed using a subtraction algorithm.

50. The method of claim 25 further comprising updating the non-volatile memories with one or more images stored in the volatile memory so as the one or more images are categorized as template images.

51. The method of claim 50, wherein the template images are categorized so as to allow the authorized person to identify the template images as being from the volatile memory.

52. The method of claim 50, wherein the authorized person modifies the template images stored from volatile memory.

53. The method of claim 25 further comprising uploading one or more template images into the non-volatile memories.

54. The method of claim 53, wherein the one or more template images are staged to show a probable reportable event.
